(19) United States
(12) Patent Application Publication
(10) Pub. No.: US 2007/0019192 A1
(43) Pub. Date: Jan. 25, 2007

(54) Laser scanning microscope

(76) Inventor: Helmut Bloos, Jena (DE)

Correspondence Address: JACOBSON HOLMAN PLLC, 400 SEVENTH STREET N.W., SUITE 600, WASHINGTON, DC, 20004, US

(21) Appl. No.: 11/416,396

(22) Filed: May 3, 2006

(30) Foreign Application Priority Data
May 3, 2005 (DE) 10 2005 020 541.0

(51) Int. Cl. G01J 3/30

(52) U.S. Cl. 356/318

(57) ABSTRACT

A Laser Scanning Microscope, preferably with line-shaped sampling, whereby illumination radiation from the Microscope is guided over a sample with at least one galvanometer scanner. The scanner has a mechanical deflection limit. A means for the determination of a current increase is provided in the scanner. On reaching a threshold value, the operating voltage of the scanner is switched off until it declines below the threshold value and preferably an optical and/or acoustic display device is provided, which displays the switching on and off of the scanner.

### BACKGROUND OF THE INVENTION

(1) Field Of The Invention

The invention relates to a Laser Scanning Microscope, preferably with a line-shaped scanning, whereby the illumination beam is guided over the sample with at least one galvanometer scanner.

(2) Description Of The Related Art

FIG. 1 shows schematically a Laser Scanning Microscope 1, which is essentially built from five components: a light source module 2, which generates the excitation radiation for the laser scanning microscopy, a scanning module 3, which conditions the excitation radiation and appropriately deflects it over the sample for scanning, a microscope module 4, shown only schematically for the sake of simplicity, which directs the scanning beam provided by the scan module in a microscopic beam path onto the sample, as well as a detector module 5, which receives and detects the optical radiation from the sample. The detector module 5 can thereby be designed for several spectral channels as shown in FIG. 1.

For a general description of a point-to-point scanning Laser Scanning Microscope, reference is made to U.S. Pat. No. 6,167,173 A, incorporated by reference herein in its entirety.

The radiation source module 2 generates the illumination beam, which is suitable for laser scanning microscopy, that is, in particular, a beam that can trigger fluorescence. For that purpose, the radiation source module 2 is provided with several radiation sources depending on the application. In one of the embodiments shown, two lasers 6 and 7 are provided in the radiation source module 2, followed in each case by a light valve 8 as well as an attenuator 9 and which couple their radiation through a coupling point 10 into optical fiber 11. The light valve 8 acts like a beam deflector, which can serve the same purpose as a beam shutter, without necessitating thereby switching off the operation of the laser in the laser unit 6 and/or 7 itself. The light valve 8 is designed, for instance, as an AOTF, which deflects the laser beam, for switching off the beam, before coupling into the optical fibers 1 1, in the direction of a light trap not shown here.

In the exemplary illustration in FIG. 1, the laser unit 6 comprises three lasers B, C, D, in contrast to which, the laser unit 7 has only one laser A. This illustration is thus an example of a combination of single-wavelength and multi-wavelength lasers, which are coupled individually or jointly to one or more fibers. The coupling can take place in several fibers at the same time, whose radiation is later mixed by a color combiner after passing through an adaptive optical system. It is thus possible to use a great diversity of wavelengths or wavelength ranges for the excitation radiation.

The radiation coupled in the optical fibers 11 is combined by means of displaceable collimation optics 12 and 13 through the beam combining mirrors 14, 15 and modified in regard to its beam profile in a beam-shaping unit.

The collimators 12, 13 serve the purpose of collimating the radiation, fed by the radiation source module 2 into the scan module 3, to an infinite beam. This is achieved with advantage in each case by using a single lens that has a focusing function, achieved through displacement along the optical axis, regulated by means of a central control unit (not shown here), whereby the distance between the collimator 12, 13 and the respective end of the optical fiber is changeable.

The beam-shaping unit, which is explained in greater detail later, generates, from a rotation symmetrical laser beam with Gaussian profile, as it appears after the beam combining mirrors 14, 15, as a line-shaped beam, which is no longer rotation symmetrical, but has a cross section that is suitable for generating a field with rectangular illumination.

This illumination beam, also line-shaped, serves as the excitation radiation and is guided to a scanner 18 through a main dichroic beam splitter 17 and a zoom optic described later. The main dichroic beam splitter 17 is described in greater detail later; suffice it to say, it has the function of separating the sample radiation returning from the microscope module 4 from the excitation radiation.

The scanner 18 deflects the line-shaped beam along one or two axes, after which it is bundled by a scanning objective 19 and an objective of the microscope module 4. Thereby the optical imaging takes place in such a manner that the sample is illuminated by the excitation radiation over a caustic curve.

The fluorescence radiation excited with the line-shaped focus in this manner, returns, passing through the objective and the tube lens of the microscope module 4 and the scanning objective 19, back to the scanner 18, so that in the returning direction, after the scanner 18, there is again a static beam. Therefore the scanner 18 is also said to de-scan the fluorescence radiation.

The main dichroic beam splitter 17 lets the fluorescence radiation with wavelengths in a range other than the excitation radiation pass through, so that it is deflected in the detector module 5 and can thereupon be analyzed. In the embodiment in FIG. 1, the detector module 5 has several spectral channels, that is, the fluorescence beam is split by a secondary dichroic beam splitter 25 into two spectral channels.

Each spectral channel has a slit diaphragm 26, which realizes a confocal or a partially confocal image with respect to a sample in the microscope module 4 and whose size determines the depth of focus with which the fluorescence beam can be detected. The geometry of the slit diaphragm 26 thus determines the plane of the cross section within the (thick) preparation, from which the fluorescence beam is detected.

Further, a block filter 27 is mounted after the slit diaphragm 26. The block filter 27 blocks the undesirable excitation light from entering into the detector module 5. The line-shaped, fanned out beam, separated in this manner, and which comes from a segment at a particular depth, is then analyzed by a suitable detector 28. Analogous to the described color channel, the second spectral detection channel is also built up in the same manner, which also comprises a slit diaphragm 26a, a block filter 27a, as well as a detector 28a.

The use of a confocal slit aperture in the detector module 5 is only an exemplary instance. Naturally, a single-point scanner can also be realized. The slit diaphragms 26, 26a are in that case replaced by pinhole diaphragms and the beam-shaping unit can be dispensed with. Besides that, in such a type of construction, all optical systems are embodied with rotational symmetry. Thus, obviously, instead of single-point scanning and single-point detection, in principle any arbitrary multipoint-arrangement, such as those with scatter plots or Nipkow disk concepts, can be employed. Of particular importance, however, is that the detector 28 performs spatial resolution, because parallel recording of several sample points takes place during the scanning cycle of the scanner.

In FIG. 1, the bundles of the beams, which have Gaussian profile after the movable, that is, displaceable collimators 12 and 13, are combined by means of a mirror staircase in the form of beam combining mirrors 14, 15, and are converted subsequently, in the shown embodiment with the confocal slit diaphragm, into a bundle of beams with rectangular beam cross section. In the embodiment in FIG. 1, a cylinder telescope 37 is used as the beam-shaping unit, after which an aspherical unit 38 is arranged in the subsequent path, followed by a cylindrical optical system 39.

After the transformation, one obtains a beam, which essentially illuminates a rectangular field in a profile plane, whereby the intensity distribution along the longitudinal axis of the field does not have a Gaussian but does have a step-like profile.

The arrangement for the illumination with the aspherical unit 38 can serve the purpose of uniform filling of a pupil between a tube lens and an objective. With that, the optical resolution of the objective can be fully utilized. This variant is thus also suitable in microscope systems with single-point or multipoint scanning, for example, in a line-scanning system (in the latter case additionally to the axis in which the focusing is done on or in the sample).

For example, the excitation radiation conditioned to the line-shape is deflected to the main dichroic beam splitter 17. The latter is embodied, in a preferred embodiment, as a spectrally neutral beam splitter according to U.S. Pat. No. 6,888,148 B2, whose disclosure is incorporated herein as if reproduced in full. Thus the term “color splitter” also includes non-spectrally acting splitter systems. In place of the described color splitters that are independent of the spectrum, a homogeneous neutral beam splitter (for example 50/50, 70/30, 80/20, or similar) or a dichroic beam splitter can also be employed. In order to enable the selection independent of the application, the main dichroic beam splitter is preferably provided with a mechanical arrangement, which enables easy replacement, for instance, by means of a corresponding beam splitter disk containing individual, exchangeable beam splitters.

If the scanner 18 is embodied as a scanner with a mechanical deflection limit (for example, GSI Lumonics VM500 made by the GSI Group, Billerica, Mass. 01821, as shown in the 2003 Product Manual), a false setting of the deflection limit can lead to the consequence that after the current supply to the scanner, the control unit of the scanner runs against a stop. This can lead to a drastic increase in the current, which, if it remains unnoticed (which is in general the case in devices with in-built scanners), the scanner can be destroyed after a short period due to overheating.

### BRIEF DESCRIPTION OF THE DRAWINGS

FIG. 1 is a schematic drawing of a Laser Scanning Microscope.

FIG. 2 is a schematic circuit diagram of the subject invention.

### DETAILED DESCRIPTION OF THE INVENTION

In the description that follows, like parts are marked throughout the specification and drawings with the same reference numerals, respectively.

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

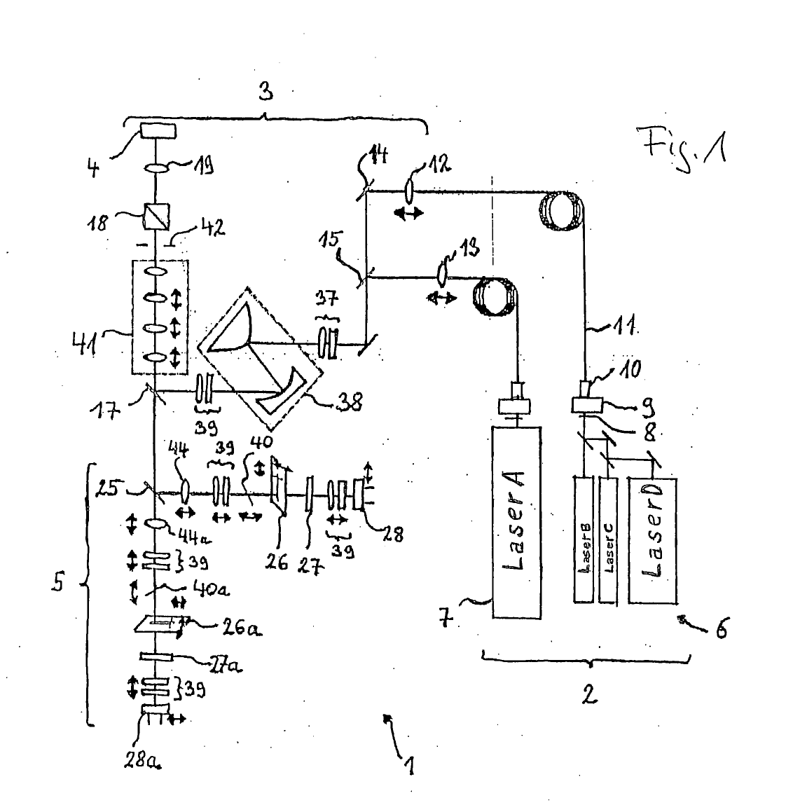

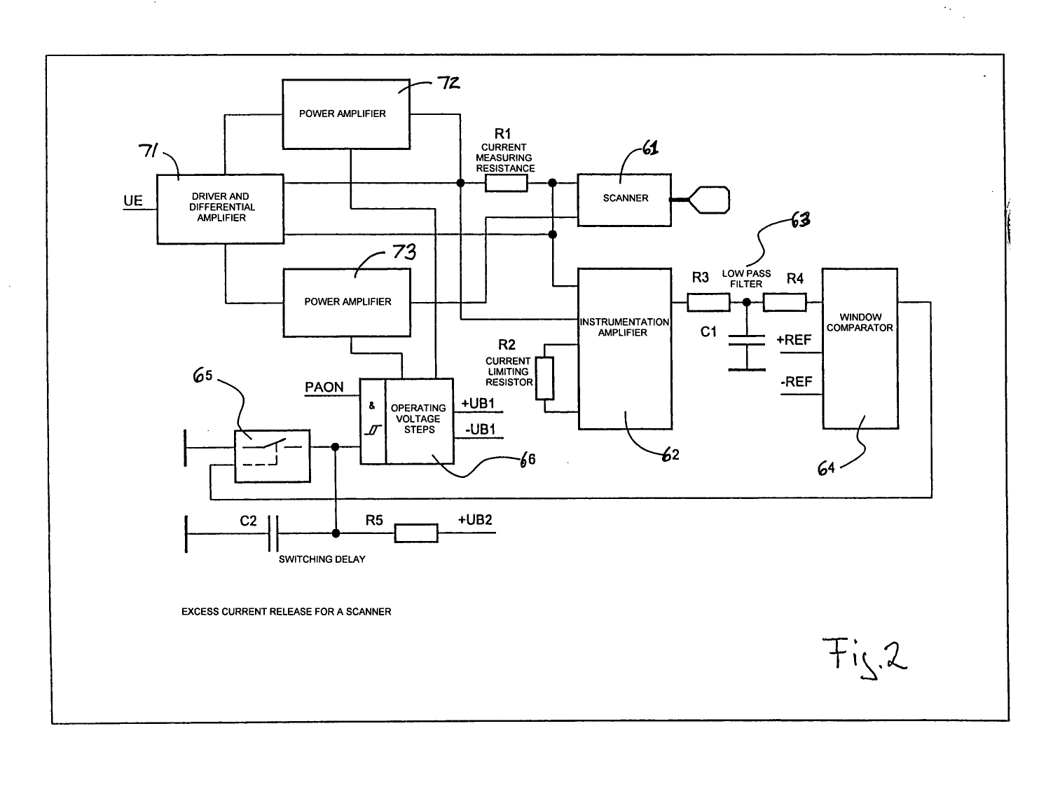

Further explanation follows on the basis of FIG. 2. Scanner 18 in FIG. 1 is scanner 61 in this case. Usually, the scanners are operated with a power amplifier that is designed as a current driver. The scanner 61, the driver stage 71 and both the power amplifiers 72, 73 are integral parts of an analog control circuit, which is familiar as such, and is shown in part in FIG. 2. The scanner comprises a position sensor, which delivers an angle-proportionate signal that is linked with the steering signal in the aforementioned control circuit. The sum signal UE built in this manner is fed to the driver stage 71, which is designed as a differential amplifier. The driver stage 71 links UE with the differential input signal, which is measured over resistor R1, and from that calculates the steering signal for the power amplifiers 72, 73, that are connected in the circuit in the conventional manner as a bridge amplifier and a current driver.

In static conditions, R1 appears only as a small differential voltage, which is actuated by the small holding current of the scanner. As soon as there is a change in UE (change in the steering signal for a new position), the output voltage of the power amplifier increases (and with that the scanner current), the scanner is then turned to an extent until UE (actuated due to the change in the position signal) takes the preceding value again. In the new position, the output voltage of the power amplifier reverts back to the value, with which the small holding current of the scanner is sustained.

If the new position cannot be assumed, because, for instance, the mechanical deflection limit setting is false, the high scanner current continues to persist, leading to excessive heating of the scanner and ultimately to its destruction.

The present invention is based on exploiting the current measuring resistance, which is always present in order to ensure the release of excess current.

The potential drop over the current measuring resistance R1 is amplified with the help of the instrumentation amplifier 62 to a voltage value that is measurable by the subsequent window comparator 64. The amplification (and hence the maximum current) is determined by the value of resistor R2. The low-pass filter 63( R3, C1 and R4) hinders a response by the comparator 64 due to the short duration of the current peaks, of the kind that appear, for instance, during the direction reversal of the scanner 61 during operation of the scanner. Only if a longer persisting large current value is detected, does it lead to a voltage value that exceeds one of the reference voltages +REF or −REF, the output of the comparator 64 of the analog switch 65 is switched on. As a result, capacitor C2 is discharged and the regulating step for the operating voltages 66 of the power amplifier switches off the operating voltages +UB1 and −UB1. Since the fault “too large current” is now no longer present, the comparator switches on again and the analog switch 65 is switched off. C2 can become charged over resistor R5 by the operating voltage +UB2 (switching delay) and switch on the operating voltages of the power amplifiers after reaching the threshold voltage of the Schmitt-Trigger input.

Since the scanner is operated only for a short period with the high current in the case of a fault, a thermal overload is ruled out. The periodical switching on and off of the scanner is audible as a periodic “clicking”, through which the user's attention is drawn to the fault. The fault can also be displayed by means of a blinking LED or through setting of an error bit in a status query.

The invention is of advantage in various scan microscopes, even in those that use more than one scanner.

The embodiments described here represent only an exemplary selection. Though not explicitly mentioned here, the arrangements according to the invention can also be used in other ways that may be obvious to the user. It is to be understood that the present invention is not limited to the illustrated embodiments described herein. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1. A Laser Scanning Microscope with line-shaped sampling of a sample the Laser Scanning Microscope comprising:
at least one source of illumination radiation:
at least one galvanometer scanner for guiding the illumination radiation over the sample:
a mechanical deflection limit provided in the galvanometer scanner:
determining means for the determining a current increase in the galvanometer scanner: and
means for switching the scanner off when the current determined by the determining means reaches a threshold value and maintaining the switch off until the determined current declines below the threshold value.

2. The Laser Scanning Microscope according to claim 1, further comprising an optical display device that displays the switching on and off of the scanner.

3. The Laser Scanning Microscope according to claim 1, further comprising an acoustic display device that displays the switching on and off of the scanner

4. An arrangement for regulating a galvanometer scanner, the arrangement comprising:
determining means for the determination of a current increase in the galvanometer; and
means for switching the scanner off when the current determined by the determining means reaches a threshold value and maintaining the switch off until the determined current declines below the threshold value.

5. The arrangement according to claim 4, further comprising an optical display device that displays the switching on and off of the scanner.

6. The arrangement according to claim 4, further comprising an acoustic display device that displays the switching on and off of the scanner.
